(19) United States
(12) Patent Application Publication
(10) Pub. No.: US 2010/0146417 A1
(43) Pub. Date: Jun. 10, 2010

(54) Adapter for Bridging Different User Interface Command Systems

(75) Inventor: Ulrich Mueller, Beverly, MA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 12/331,460

(22) Filed: Dec. 10, 2008

(51) Int. Cl. G06F 3/00

(52) U.S. Cl. 715/762; 715/700

(57) ABSTRACT

A user interface that may utilize two different command routing protocols may be provided. The two different command routing protocols may comprise a first command routing protocol and a second command routing protocol. The first command routing protocol may use a pull model. The second command routing protocol may use a push model. The first command routing protocol may be statically predefined in Extensible Markup Language (XML). The second command routing protocol may be built dynamically at runtime when commands are pushed synchronously into user interface command containers. The user interface may be displayed comprising a ribbon having a plurality of tabs.

### BACKGROUND

To provide a consistent “look and feel,” software providers may wish to provide a consistent user interface (UI) between individual application tools within a suite of application tools. While some of the individual application tools may be developed with a command routing protocol compatible with the consistent UI, others of the individual application tools may comprise “legacy” software tools developed with a legacy command routing protocol not compatible with the consistent UI. One solution to this UI incompatibility problem is to rewrite the legacy software tools to work with the consistent UI. In order to leverage the legacy software tools without rewriting them, it is desirable to have a way to bridge the legacy software tools to the aforementioned consistent UI.

### SUMMARY

This Summary is provided to introduce a selection of concepts in a simplified form that are further described below in the Detailed Description. This Summary is not intended to identify key features or essential features of the claimed subject matter. Nor is this Summary intended to be used to limit the claimed subject matter's scope.

A user interface that may utilize two different command routing protocols may be provided. The two different command routing protocols may comprise a first command routing protocol and a second command routing protocol. The first command routing protocol may use a pull model. The second command routing protocol may use a push model.

Both the foregoing general description and the following detailed description provide examples and are explanatory only. Accordingly, the foregoing general description and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present invention. In the drawings:

FIG. 1 is a block diagram of an operating environment;

FIG. 2 shows a mapping environment;

FIG. 3 is a flow chart of a method for providing user interface bridging; and

FIG. 4 is a block diagram of a system including a computing device.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

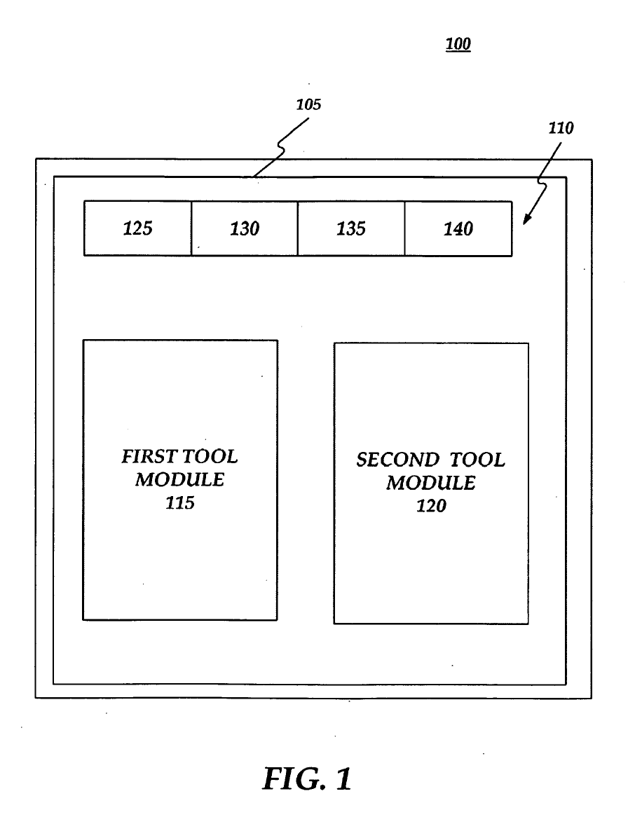

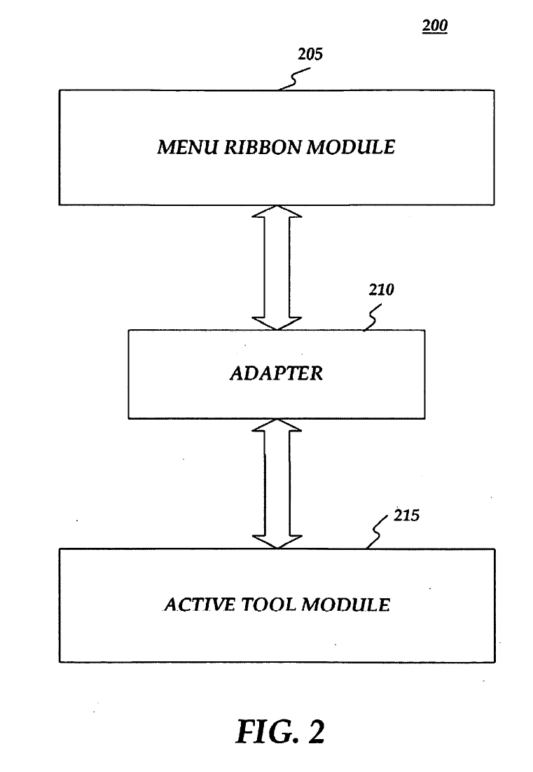

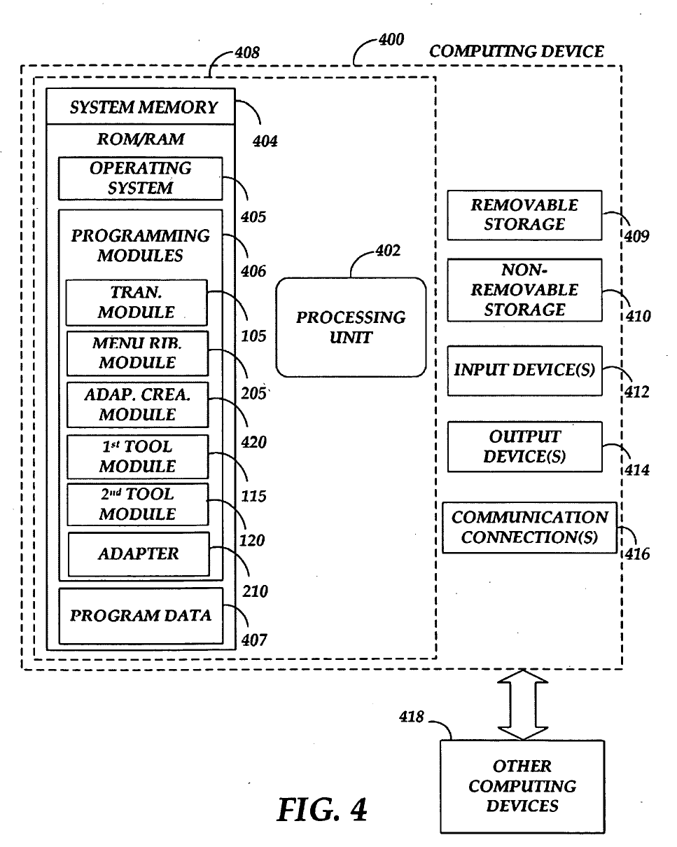

Interface bridging may be provided. Consistent with embodiments of the present invention, an adapter interface may bridge different user interface (UI) command routing protocols (e.g. systems.) FIG. 1 shows an operating environment 100. As shown in FIG. 1, environment 100 may be displayed on an output device (e.g. one of output devices 414 as described below with respect to FIG. 4) comprising, for example, a display. Operating environment 100 may include a transceiver module 105, a user interface module 110, a first tool module 115, and a second tool module 120. User interface module 110 may comprise, but is not limited to, a menu ribbon module (e.g. a menu ribbon module 205 as described below with respect to FIG. 2.) User interface 110 may include a plurality of tabs 125, 130, 135, and 140. Transceiver module 105 may contain and control user interface module 110 and may know which of first tool module 115 and second tool module 120 is currently active. First tool module 115 or second tool module 120 may become an active tool module, for example, when a user changes the focus of operating environment 100 to a respective one of first tool module 115 or second tool module 120.

First tool module 115 may employ a first command routing protocol and second tool module 120 may employ a second command routing protocol. The first command routing protocol may employ a pull model to assemble its UI command hierarchy while the second command routing protocol may employ a push model to assemble its UI command hierarchy.

The first command routing protocol as well as the routing protocol for user interface 110 may be statically predefined, for example, in Extensible Markup Language (XML). However, the second command routing protocol may be built dynamically at runtime when commands are pushed synchronously into UI command containers (e.g. at tool change time, and when focus changes.)

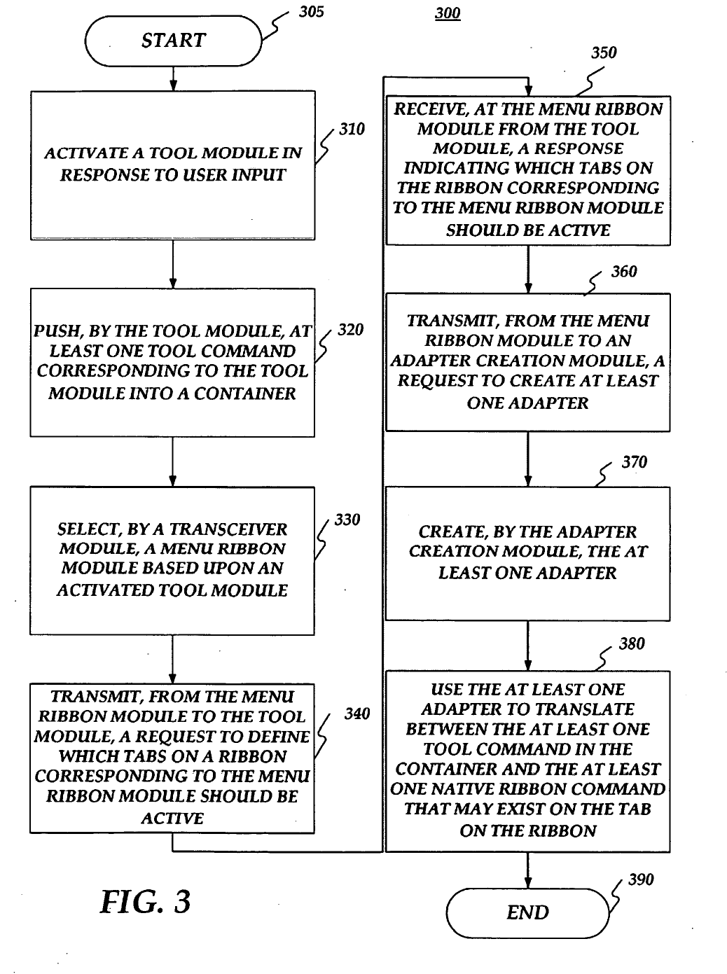

Embodiments of the invention may remap native control user objects of a “push” routing protocol to new UI command objects to work with a “pull” routing protocol as the native control user objects go in and out of existence in the push routing protocol. FIG. 2 shows a mapping environment 200. As shown in FIG. 2, mapping environment 200 may include menu ribbon module 205, an adapter 210, and an active tool module 215. Menu ribbon module 205 may comprise user interface module 110 and active tool module 215 may comprise one of first tool module 115 and second tool module 120. Menu ribbon module 205 may employ a first command routing protocol and active tool module 215 may employ a second command routing protocol. As stated above, the first command routing protocol may employ a pull model to assemble its UI command hierarchy while the second command routing protocol may employ a push model to assemble its UI command hierarchy. Consequently, as described in more detail below with respect to FIG. 3, adapter 210 may be created and used to bridge these two different command routing protocols (e.g. push and pull.)

FIG. 3 is a flow chart setting forth the general stages involved in a method 300 consistent with an embodiment of the invention for providing user interface bridging. Method 300 may be implemented using a computing device 400 as described in more detail below with respect to FIG. 4. Ways to implement the stages of method 300 will be described in greater detail below. Method 300 may begin at starting block 305 and proceed to stage 310 where computing device 400 may activate a tool module in response to user input. For example, the user may be working within operating environment 100. While working within operating environment 100, the user may change focus of operating environment 100 between first tool module 115 and second tool module 120. The activate tool module may comprise which of first tool module 115 and second tool module 120 the user is currently focused into (e.g. active tool module 215.)

From stage 310, where computing device 400 activates the tool module (e.g. active tool module 215) in response to the user input, method 300 may advance to stage 320 where computing device 400 may push, by active tool module 215, at least one tool command corresponding to active tool module 215 into a container. For example, active tool module 215 may employ a “push” command routing protocol. In other words, commands in active tool module 215 may be built dynamically at runtime of active tool module 215 when commands are pushed synchronously into UI command containers.

Once computing device 400 pushes, by active tool module 215, the at least one tool command corresponding to active tool module 215 into the container in stage 320, method 300 may continue to stage 330 where computing device 400 may select, by transceiver module 105, menu ribbon module 205 based upon active tool module 215. For example, transceiver module 105 may contain and control menu ribbon module 205 (e.g. user interface module 110) and may know which of first tool module 115 and second tool module 120 is active tool module 215. Because transceiver module 105 may know which tool module is activated, transceiver module 105 may know what tabs active tool module 215 should show in menu ribbon module 205.

After computing device 400 pushes the at least one tool command corresponding to active tool module 215 into the container in stage 330, method 300 may proceed to stage 340 where computing device 400 may transmit, from menu ribbon module 205 to active tool module 215, a request to define which tabs (e.g. plurality of tabs 125, 130, 135, and 140) on a ribbon corresponding to menu ribbon module 205 should be active (e.g. visible.) For example, while transceiver module 105 may know which ribbon to display, for a given situation, it may not know which of plurality of tabs 125, 130, 135, and 140 to make visible. Consequently, menu ribbon module 205 may ask active tool module 215 which tabs to make visible.

From stage 340, where computing device 400 transmits the request to define which tabs on the ribbon should be active, method 300 may advance to stage 350 where computing device 400 may receive, at menu ribbon module 205 from active tool module 215, a response indicating which tabs on the ribbon corresponding to menu ribbon module 205 should be active. For example, in response to the request from menu ribbon module 205, active tool module 215 may indicate to menu ribbon module 205 which of plurality of tabs 125, 130, 135, and 140 to make visible for a given situation.

Once computing device 400 receives the response indicating which tabs on the ribbon corresponding to menu ribbon module 205 should be active in stage 350, method 300 may continue to stage 360 where computing device 400 may transmit, from menu ribbon module 205 to an adapter creation module 420, a request to create at least one adapter 210. Adapter 210 may be configured to translate between at least one tool command in the container and at least one native ribbon command that may exist on the tab. The at least one tab may be indicated in the response as being one that should be active (e.g. visible.) Because menu ribbon module 205 may employ a different command routing protocol than active tool module 215, a gap between these two command routing protocols may exist. In order to bridge this gap, adapter creation module 420 may be used to create adapter 210. Adapter 210 may remap active tool module 215's native ribbon control user objects to new UI command objects as active tool module 215's command objects go in and out of existence.

After computing device 400 transmits the request to create adapter 210 in stage 360, method 300 may proceed to stage 370 where computing device 400 may create, by adapter creation module 420, adapter 210. For example, as stated above, menu ribbon module 205 may employ a first command routing protocol and active tool module 215 may employ a second command routing protocol. The first command routing protocol may employ a pull model to assemble its UI command hierarchy while the second command routing protocol may employ a push model to assemble its UI command hierarchy. Consequently, adapter 210 may be created to bridge these two different command routing protocols (e.g. push and pull.) Specifically, active tool module 215's command objects may utilize uniform resource locators (URLs). Menu ribbon module 205 may employ tool bar control IDs (TICDs) identifying one of plurality of tabs 125, 130, 135, and 140. Accordingly, adapter 210 may map active tool module 215's URLs to menu ribbon module 205's TICDs.

Once computing device 400 creates adapter 210 in stage 370, method 300 may continue to stage 380 where computing device 400 may use adapter 210 to translate between the at least one tool command in the container and native ribbon commands that may exist on the tab. For example, adapter 210 may be used to remap active tool module 215's native ribbon control user objects to new UI command objects as active tool module 215's command objects go in and out of existence. Once computing device 400 uses adapter 210 to translate in stage 380, method 300 may then end at stage 390.

An embodiment consistent with the invention may comprise a system for providing user interface bridging. The system may comprise a memory storage and a processing unit coupled to the memory storage. The processing unit may be operative to provide a user interface from two different command routing protocols. The two different command routing protocols may comprise a first command routing protocol that uses a pull model and a second command routing protocol that uses a push model.

Another embodiment consistent with the invention may comprise a system for providing user interface bridging. The system may comprise a memory storage and a processing unit coupled to the memory storage. The processing unit may be operative to create a user interface from two different command routing protocols. The two different command routing protocols may comprise a first command routing protocol that uses a pull model and a second command routing protocol that uses a push model. In addition, the processing unit may be operative to display the user interface.

Yet another embodiment consistent with the invention may comprise a system for providing user interface bridging. The system may comprise a memory storage and a processing unit coupled to the memory storage. The processing unit may be operative to select, by a transceiver module, a menu ribbon module based upon an activated tool module. In addition, the processing unit may be operative to transmit, from the menu ribbon module to the tool module, a request to define which tabs on a ribbon corresponding to the menu ribbon module should be active. Moreover, the processing unit may be operative to receive, at the menu ribbon module from the tool module, a response indicating which tabs on the ribbon corresponding to the menu ribbon module should be active. Furthermore, the processing unit may be operative to transmit, from the menu ribbon module to an adapter creation module, a request to create at least one adapter configured to translate between at least one tool command in a container and native ribbon commands that may exist on the tab. The at least one tab may be indicated in the response as being one that should be active. Also, the processing unit may be operative to create, by the adapter creation module, the at least one adapter.

FIG. 4 is a block diagram of a system including computing device 400. Consistent with an embodiment of the invention, the aforementioned memory storage and processing unit may be implemented in a computing device, such as computing device 400 of FIG. 4. Any suitable combination of hardware, software, or firmware may be used to implement the memory storage and processing unit. For example, the memory storage and processing unit may be implemented with computing device 400 or any of other computing devices 418, in combination with computing device 400. The aforementioned system, device, and processors are examples and other systems, devices, and processors may comprise the aforementioned memory storage and processing unit, consistent with embodiments of the invention. Furthermore, computing device 400 may comprise an operating environment for system 100 as described above. System 100 may operate in other environments and is not limited to computing device 400.

With reference to FIG. 4, a system consistent with an embodiment of the invention may include a computing device, such as computing device 400. In a basic configuration, computing device 400 may include at least one processing unit 402 and a system memory 404. Depending on the configuration and type of computing device, system memory 404 may comprise, but is not limited to, volatile (e.g. random access memory (RAM)), non-volatile (e.g. read-only memory (ROM)), flash memory, or any combination. System memory 404 may include operating system 405, one or more programming modules 406, and may include a program data 407. Operating system 405, for example, may be suitable for controlling computing device 400's operation. In one embodiment, programming modules 406 may include, for example, transceiver module 105, first tool module 115, second tool module 120, menu ribbon module 205, adapter 210, or adapter creation module 420. Furthermore, embodiments of the invention may be practiced in conjunction with a graphics library, other operating systems, or any other application program and is not limited to any particular application or system. This basic configuration is illustrated in FIG. 4 by those components within a dashed line 408.

Computing device 400 may have additional features or functionality. For example, computing device 400 may also include additional data storage devices (removable and/or non-removable) such as, for example, magnetic disks, optical disks, or tape. Such additional storage is illustrated in FIG. 4 by a removable storage 409 and a non-removable storage 410. Computer storage media may include volatile and nonvolatile, removable and non-removable media implemented in any method or technology for storage of information, such as computer readable instructions, data structures, program modules, or other data. System memory 404, removable storage 409, and non-removable storage 410 are all computer storage media examples (i.e. memory storage). Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 400. Any such computer storage media may be part of device 400. Computing device 400 may also have input device(s) 412 such as a keyboard, a mouse, a pen, a sound input device, a touch input device, etc. Output device(s) 414 such as a display, speakers, a printer, etc. may also be included. The aforementioned devices are examples and others may be used.

Computing device 400 may also contain a communication connection 416 that may allow device 400 to communicate with other computing devices 418, such as over a network in a distributed computing environment, for example, an intranet or the Internet. Communication connection 416 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 404, including operating system 405. While executing on processing unit 402, programming modules 406 (e.g. transceiver module 105, user interface module 110, first tool module 115, second tool module 120, menu ribbon module 205, adapter 210, or adapter creation module 420) may perform processes including, for example, one or more method 300's stages as described above. The aforementioned process is an example, and processing unit 402 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

All rights including copyrights in the code included herein are vested in and the property of the Applicant. The Applicant retains and reserves all rights in the code included herein, and grants permission to reproduce the material only in connection with reproduction of the granted patent and for no other purpose.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

What is claimed is:

1. A system for providing user interface bridging, the system comprising:
a memory storage; and
a processing unit coupled to the memory storage, wherein the processing unit is operative to provide a user interface from two different command routing protocols, the two different command routing protocols comprising a first command routing protocol that uses a pull model and a second command routing protocol that uses a push model.

2. The system of claim 1, wherein the processing unit is operative to display the user interface.

3. The system of claim 1, wherein the processing unit is operative to display the user interface comprising a ribbon having a plurality of tabs.

4. The system of claim 1, wherein the first command routing protocol is statically predefined.

5. The system of claim 1, wherein the first command routing protocol is statically predefined in Extensible Markup Language (XML).

6. The system of claim 1, wherein the second command routing protocol is built dynamically at runtime.

7. The system of claim 1, wherein the second command routing protocol is built dynamically at runtime when commands are pushed synchronously into user interface command containers.

8. A computer-readable medium that stores a set of instructions which when executed perform a method for providing interface bridging, the method executed by the set of instructions comprising:
creating a user interface from two different command routing protocols, the two different command routing protocols comprising a first command routing protocol that uses a pull model and a second command routing protocol that uses a push model; and
displaying the user interface.

9. The computer-readable medium of claim 8, wherein creating the user interface comprises creating the user interface wherein the second command routing protocol is built dynamically at runtime when commands are pushed synchronously into user interface command containers.

10. The computer-readable medium of claim 8, wherein creating the user interface comprises creating the user interface wherein the first command routing protocol is statically predefined in Extensible Markup Language (XML).

11. The computer-readable medium of claim 8, wherein displaying the user interface comprises displaying the user interface wherein the user interface comprising a ribbon having a plurality of tabs.

12. A method for providing user interface bridging, the method comprising:
selecting, by a transceiver module, a menu ribbon module based upon an activated tool module;
transmitting, from the menu ribbon module to the tool module, a request to define which tabs on a ribbon corresponding to the menu ribbon module should be active;
receiving, at the menu ribbon module from the tool module, a response indicating which tabs on the ribbon corresponding to the menu ribbon module should be active;
transmitting, from the menu ribbon module to an adapter creation module, a request to create at least one adapter configured to translate between at least one tool command in a container and at least one tab on the ribbon, the at least one tab being indicated in the response as being one that should be active; and
creating, by the adapter creation module, the at least one adapter.

13. The method of claim 12, further comprising activating the tool module in response to user input.

14. The method of claim 13, further comprising in response to being activated, pushing, by the tool module, the at least one tool command corresponding to the tool module into the container.

15. The method of claim 12, further comprising using the at least one adapter to translate between the at least one tool command in the container and the at least one native ribbon command that exists on the tab.

16. The method of claim 12, creating the at least one adapter comprises mapping between two different command routing protocols comprising a first command routing protocol that uses a push model and a second command routing protocol that uses a pull model.

17. The method of claim 16, wherein creating the at least one adapter comprises creating the at least one adapter wherein the first command routing protocol is statically predefined.

18. The method of claim 17, wherein creating the at least one adapter comprises creating the at least one adapter wherein the first command routing protocol is statically predefined in Extensible Markup Language (XML).

19. The method of claim 16, wherein creating the at least one adapter comprises creating the at least one adapter wherein the second command routing protocol is built dynamically at runtime.

20. The method of claim 19, wherein creating the at least one adapter comprises creating the at least one adapter wherein the second command routing protocol is built dynamically at runtime when commands are pushed synchronously into the container.
